(19) United States
(12) Patent Application Publication
(10) Pub. No.: US 2002/0055824 A1
(43) Pub. Date: May 9, 2002

(54) Measurement data controlling device

(75) Inventor: Masayuki Shibata, Kameoka-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 09/978,587

(22) Filed: Oct. 18, 2001

(30) Foreign Application Priority Data
Nov. 9, 2000 (JP) 2000-341464

(51) Int. Cl. G06F 17/40; G06F 15/00

(52) U.S. Cl. 702/187

(57) ABSTRACT

A device name data storing area and a measurement date-and-time data storing area are provided in a data file for storing measurement data. When measurement data are stored, the device name data and the measurement date-and-time data are also stored at the same time. A combination of the device name and the measurement date-and-time corresponds to only one measurement. Therefore, even if the file name and the measurement date-and-time contained in the data file are altered or falsified later, when the device name and the measurement date-and-time in the file are read, it can be easily determined whether at least the file is desired one or not.

### Background of the Invention and Related Art Statement

The invention relates to a measurement data controlling device for storing and controlling the measurement data collected from a measuring apparatus including an analyzer and other measuring devices included in a measuring system.

Recently, even in a field of measurement including analyzer, such as chromatograph analyzer, it has been practiced that a plurality of same-type analyzers is connected to a management control unit, i.e. mainly a personal computer or work station, instead of operating them separately, to carry out a centralized control. Further, a larger scale of analyzing system has been organized by connecting a plurality of the management control units to a network, such as LAN. Thus, analyzing conditions and data processing conditions in the plural analyzers are controlled in a centralized system and used as a common data base. Furthermore, the analyzed results are also centralized to be maintained therein, and if necessary, the results are subjected to comparison or integration with the results obtained from a different analyzer to thereby obtain data.

In the analyzing system as described above, the measurement data collected from the analyzers are stored and controlled as a file for each measurement unit. Normally, such a file is labeled with a file name, and an operator can identify the data file by the file name. Also, for example, in case the measured data collected by a number of the analyzers are unitarily controlled, when the measurement data are stored in the common data base, a series of number is assigned to each file and the data file can be identified by the serial number.

However, in the conventional analyzing system, the file names and the serial numbers can be relatively easily rewritten by an operator accessible to a computer for controlling the files. Of course, the data controlling device in the conventional analyzing system is provided with a security control in various levels. For example, there has been considered a countermeasure such that a regular operator other than a system manager can not delete the data. However, if the regular operator obtains the same level of power as that of the system manager, the operator can relatively easily alter or falsify the information, such as file name. In this case, in the conventional system, it has been difficult to find out whether the name of the data file is altered or falsified.

Recently, in order to establish reliability on the food inspection, development of new medical supplies and the like, standards, i.e. regulations, such as “Good Laboratory Practice” (hereinafter referred to as “GLP”) and “Good Manufacturing Practice” (hereinafter referred to as “GMP”), have been introduced. In GLP and GMP, stringent standards for controlling the data obtained from the results of examinations, inspections and the like have been established. In the measuring and analyzing instruments matching the standards, it is necessary to prevent the data from being intentionally or unintentionally rewritten or deleted. From that reason, there has been increasing the necessity of easily finding out the alteration or falsity of the file name of the data file as described above.

In view of the above demand, the present invention has been made and an object of the invention is to provide a measurement data controlling device for a measuring apparatus, wherein identification of a data file can be positively carried out, and even if there is an alteration or falsity of the file name, at least the fact is firmly and easily found out.

Further objects and advantages of the invention will be apparent from the following description of the invention.

### SUMMARY OF THE INVENTION

In order to attain the above object, in the measurement data controlling device for storing and controlling measurement data collected by the measurement device or the plural measurement devices in the measurement system, when the measurement data are stored as a file for each measurement unit, device identification data for identifying a measurement device from other devices and time identification data for identifying date and time when the measurement is carried out are stored in predetermined areas of the file.

Here, for example, the device identification data may be device name codes assigned to the respective plural measurement devices. A plurality of analyses can not be carried out at the same time by one measurement device. Therefore, there are no different measurement data having the same combination of the device identification data and the time identification data, so that only the file containing the collected measurement data can be identified.

### BRIEF DESCRIPTION OF THE DRAWINGS

FIG. 1 is a block diagram showing a whole structure of an analyzing system using a measurement data controlling device of an embodiment according to the invention;

FIGS. 2(a) and 2(b) are conceptual drawings of a file in the measurement data controlling device of the embodiment;

FIG. 3 is a conceptual drawing of a file of another embodiment;

FIG. 4 is a conceptual drawing of a file of still another embodiment; and

FIG. 5 is a conceptual drawing of a consecutive analysis definition file of a still further embodiment.

### DETAILED DESCRIPTION OF PREFERRED EMBODIMENTS

Hereunder, embodiments of a measurement data controlling device according to the present invention will be explained with reference to the accompanying drawings.

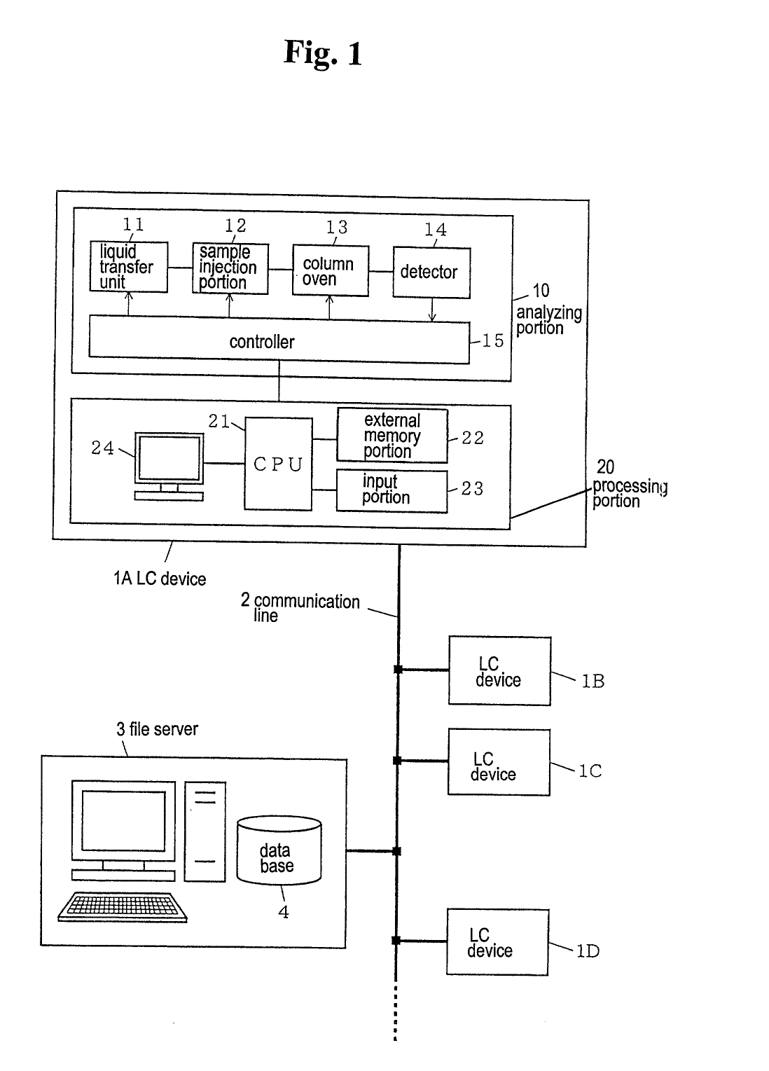

FIG. 1 is a block diagram showing a whole structure of an analyzing system, as a measurement device, using a measurement data controlling device. In the present embodiment, an analyzer represents a liquid chromatograph analyzer (hereinunder, referred to as “LC” device), but the measurement device is not limited thereto.

Each of the respective LC devices 1A, 1B, 1C, D, (hereinunder, the LC devices are represented by only numeral “1”) includes an analyzing portion 10 for carrying out measurement of a sample and obtaining data thereof; and a processing portion 20 for preparing a chromatogram by analyzing the data obtained at the analyzing portion 10, or carrying out an operation process, such as a qualitative analysis and quantitative analysis, based on the chromatogram.

The analyzing portion 10 includes a liquid transfer unit 11, a sample injection portion 12, a column oven 13 and a detector 14, and the respective portions are controlled by a controller 15 based on an instruction from the processing portion 20. On the other hand, the processing portion 20 is actually a personal computer including a CPU 21 as a main portion, an external memory portion 22 like a hard disk, an input portion 23 like a keyboard and a display portion 24 like a CRT display.

The respective LC devices 1 are connected to a communication line 2, such as LAN, through which they are connected to a file server 3. The file server 3 is actually a computer, and has a standard structure as a computer. Especially, the file server 3 includes an external memory of a large capacity, in which a data base 4 including a data file and the like is organized. The principal function of the file server 3 is to receive the measurement data and measurement condition data from the processing portion 20 of each LC device 1 through the communication line 2, and to unitarily store and control them as a data base.

In case an analysis is carried out in each LC device 1, an analyst inputs the necessary information, such as the analyzing conditions and data processing conditions, from the input portion 23. The CPU 21 carries out an analysis by controlling the respective portions in the analyzing portion 10 through the controller 15 based on the thus inputted conditions. More specifically, an eluant is sent out from the liquid transfer unit 11, a liquid sample is injected into the eluant at the sample injection portion 12 and then the mixed liquid is sent to the column provided in the column oven 13. While the liquid sample passes through the column, the liquid sample is separated into the respective components, and the separated components reach the detector 14 with different arrival times. The detector 14 outputs signals corresponding to the respective components. The detected signals are sent to the processing portion 20 through the controller 15, and a chromatogram is formed based on the received signals and displayed on the display portion 24. Also, data processings for a qualitative analysis and a quantitative analysis are carried out based on predetermined data analyzing conditions, and the results thereof are displayed on the display portion 24.

After a series of the processings, all the raw data obtained from the detector 14 and the data obtained by subjecting the raw data to a process or operational process are held in one file as a bunch of measurement data. At this time, in the present embodiment, the following characteristic file control is carried out.

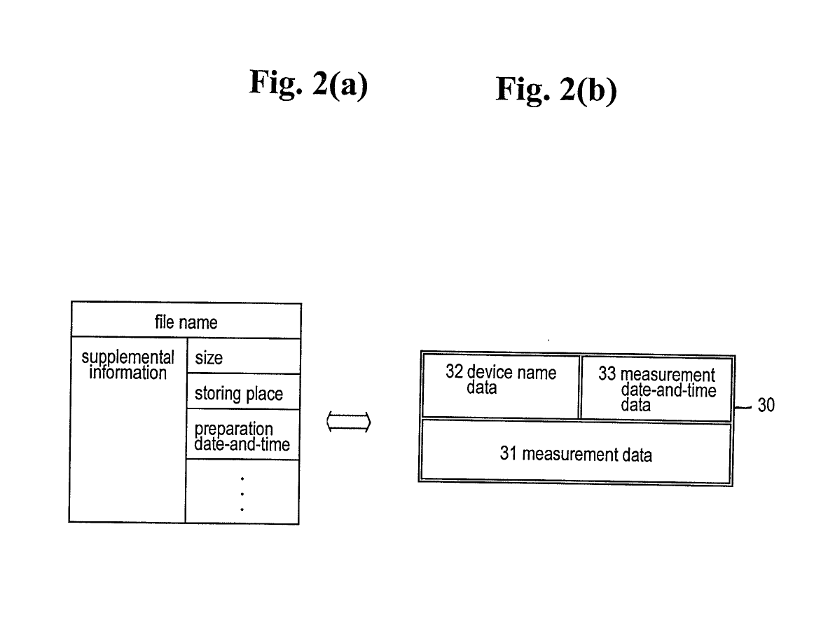

FIGS. 2(a) and 2(b) show conceptual drawings of a file according to the present embodiment. As shown in FIG. 2(b), a large quantity of measurement data 31 obtained by one measurement is contained in a data file 30. At the same time, the data file 30 is provided with a storing area 32 of device-name data for specifying each LC device 1, and a storing area 33 of measurement date-and-time data for showing the date and time when the analysis is carried out. The device-name data and the measurement date-and-time data to be stored in the storing areas are provided in the data file 30. For example, when the file is copied, these data as well as the measurement data 31 are copied.

On the other hand, FIG. 2(a) is a file allocation table, and the contents thereof, such as file name and supplemental information which are external information relative to the data file 30, are the same as those in a conventional device. Therefore, in case an operator having a predetermined authority carries out the normal filing operation controlled by an operating system, such as copying and transferring, the data file, i.e. measurement data, can be identified by using the file name in the file allocation table.

In each LC device 1, after the above-stated measurement is completed, when the measurement data are stored in the external memory portion 22 as a file, the CPU 21 stores the device name of the LC device in the storing area 32 of the device name data, and stores the measurement date and time in the storing area 33 of the measurement date-and-time data. The device name is a name or ID code assigned to only the device, which is not the same as those assigned to the other devices in not only the present analyzing system but also other systems. For example, in case the data file 30 is sucked by or transferred to the file server 3 through the communication line 2, the device name data and measurement date-and-time data are contained in the data file 30 without fail. Also, in case the data file 30 is stored in a removable memory medium, such as a floppy disk and CD-R, and taken out to the outside, the device name data and the measurement date-and-time data are contained in the data file 30 without fail.

In the analyzer of this type, it is impossible to carry out two measurements in parallel by the same device at the same time. Therefore, the combination of the device name data and the measurement date-and-time data corresponds to only one measurement. In other words, this combination is useful as information for identifying only one measurement among the enormous number of measurements. In this case, the device name data and the measurement date-and-time data in the data file 30 can be read out and displayed according to a predetermined operation from the input portion of the file server 3 or the input portion 23 of each LC device 1. Although the device name data and the measurement date-and-time data stored in the data file 30 are not normally used, for example, in case reliability in the storage of the measurement data is doubted, the device name data and measurement date-and-time data are read out by carrying out the above-stated predetermined operations. Then, whether the information, such as the file name, in the file allocation table is rewritten or not is determined by examining whether the device name and measurement date-and-time are appropriate, or whether any inconsistence in the light of the other conditions exists or not.

Generally, the file allocation table storing the file name and the like can be relatively easily rewritten by a person having an authority accessible to the system. On the contrary, the device name data and the measurement date-and-time data in the data file 30 can not be distinguished from the measurement data by just looking at the data contents. Also, it takes a great labor to alter or falsify them. Further, these data are not often unintentionally rewritten by normal operational errors or the like. Therefore, when compared with a case where the measurement data are identified by only the file name as conventionally carried out, the measurement data can be identified more precisely, and alteration or falsity of the information in carrying out false identification can be also highly protected.

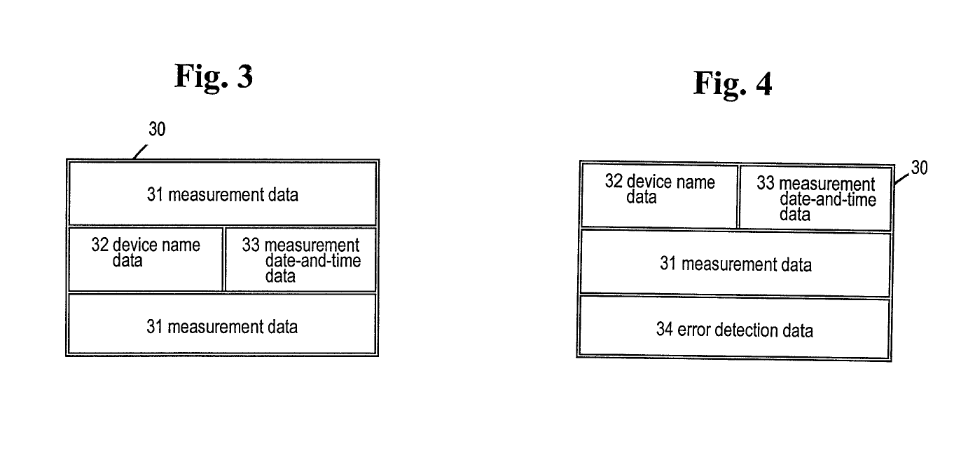

Incidentally, in the embodiment as shown in FIGS. 2(a) and 2(b), the storing areas 32 and 33 for the device name data and the measurement date-and-time data, respectively, are provided at the top of the data file 30. However, in view of intentionally preventing the data in the data file from being altered or falsified, as shown in FIG. 3, it is preferable that the storing areas 32 and 33 are provided between the two measurement data 31. According to this device, since it is difficult to distinguish the device name data and the measurement date-and-time data from the measurement data by only looking at the data contents, the alteration or falsity of the device name data and the measurement date-and-time data can be more effectively prevented.

Further, according to the following manner, even in case the device name data and the measurement date-and-time data stored in the file are rewritten, the rewritten fact can be easily detected. FIG. 4 is a conceptual drawing of a file of another embodiment. In the example, error detection codes are produced from all of the device name data, measurement date-and-time data and measurement data, and the codes are stored in a predetermined error detection code storing area 34. As the error detection codes, various codes, such as a parity and CRCC which are conventionally known, can be used. With this structure, for example, in case a part of the data in the data file 30 is rewritten, it can be ascertained that at least a part of the data is rewritten by carrying out an error detection operation process by using the error detection code. Therefore, even in case a part of the data is falsified, there is a good possibility of detecting it.

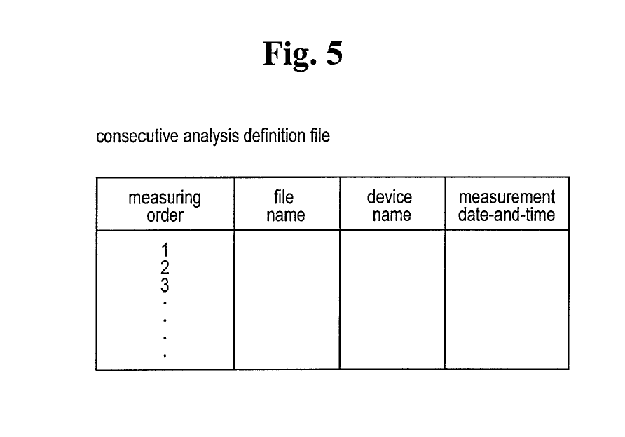

Also, generally, in case a series of consecutive analyses is carried out while automatically consecutively changing a plurality of samples in the same LC device, in order to identify the plural data files with respect to the consecutive analyses, consecutive analysis definition files are made. In the definition file of the conventional device, the order of the file names is defined with respect to only the analyzing order. However, according to the measurement data controlling device of the invention, as shown in FIG. 5, the device name data and the measurement date-and-time data stored in the data file are also included in the definition file. With this structure, for example, even if the file name of the data file obtained at another time different from the consecutive analyses is altered to correspond to the definition file of the consecutive analyses, since the device name data and the measurement date-and-time data stored in the data file do not correspond to those in the definition file, it is easily determined that the corresponding relationship is not correct. Since the analyzing continuity and order are often important in case of the consecutive analyses, it is greatly useful to verify whether the order as well as the contents of the measurement data defined in the definition file are correct or not.

Furthermore, in order to make it difficult to distinguish a difference of the device name data and the measurement date-and-time data from the measurement data, all or a part of these data may be coded; or the device name data and the measurement date-and-time data themselves may be stored in a dispersed state as several fragmentary data. Also, by writing the device name data and the measurement date-and-time data in duplicate, even if one of the data is damaged, the original data can be easily recovered.

Incidentally, the above described embodiment is one example, and it is apparent that many other variations and modifications may be made provided that they do not depart from the subject of the invention.

As described above, in the measurement data controlling device according to the present invention, even if a file name stored relating to the file is intentionally or unintentionally rewritten later, whether the file is what is really wanted can be easily determined by reading out the device identifying data and time identifying data stored in the file. Also, the data stored in the file of the measurement data are controlled by an operating system and it is very difficult to find out and alter the data since the troublesome works are required more than that required in altering the data, such as the file name, which can be easily altered by a person who obtains an authority accessible to the system. Thus, the measurement data controlling device of the invention has an effect of discouraging the falsity. As described above, according to the measurement data controlling device of the invention, storage and control of the measurement data can be positively and safely carried out.

While the invention has been explained with reference to the specific embodiments of the invention, the explanation is illustrative and the invention is limited only by the appended claims.

What is claimed is:

1. A measurement data controlling device for storing and controlling measurement data in a measurement system including a plurality of measurement devices, comprising:
a memory formed in each measurement device, and
means for preparing a main file having a plurality of predetermined areas for storing measured data, identifying data for identifying a measuring device from other measuring devices, and time identifying data for identifying date-and-time when a measurement is carried out in said each measurement device, said main file being stored in the memory as one file unit.

2. A measurement data controlling device according to claim 1, wherein said preparing means further prepares a file allocation table attached to the main file containing a file name and preparation time of the main file, to be used in operating the main file.

3. A measurement data controlling device according to claim 2, wherein said measured data are divided into two areas, said identifying data and time identifying data being located between the two areas.

4. A measurement data controlling device according to claim 2, wherein said preparing means further prepares error detection data for the measured data, identifying data and time identifying data, which are attached to the main file.

5. A measurement data controlling device according to claim 2, further comprising a communication line connected to said plurality of measurement devices, and a file server connected to the communication line.

6. A measurement data controlling device according to claim 2, wherein said measurement device is an analyzer of a material.
